(19) United States
(12) Patent Application Publication
(10) Pub. No.: US 2006/0128423 A1
(43) Pub. Date: Jun. 15, 2006

(54) Integration system of different types of mobile switching centers and supporting method and apparatus

(75) Inventors: Robert Horvath, Arlington Heights, IL (US); Lloyd J. Johnson, Scottsdale, AZ (US); Bruce A. Oltman, Schaumburg, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 11/010,765

(22) Filed: Dec. 13, 2004

(51) Int. Cl. H04Q 7/20

(52) U.S. Cl. 455/552.1; 455/507

(57) ABSTRACT

An integration system using multiple types of MSCs (12, 14) has been provided. An access request from a mobile station (22, 24, 26) is first determined (36) whether it is associated with a second type of MSC. If so, the access request is routed (38) to a MSC of the second type. Otherwise, it is determined (42) whether the access request is a registration, and if so, the access request is also routed (38) to a MSC of the second type for the registration processing. At the registration process, it is determined (82) whether the access request should be associate with the second type of MSC, and if so, an association as such is assigned (86) between the mobile station and the second type of MSC.

### TECHNICAL FIELD

This invention relates generally to different types of mobile switching centers as are used in communication networks.

### BACKGROUND

The demand for the use of various types of data, such as images and videos, in the cellular industry has drastically increased in the past few years. Cellular wireless systems are no longer limited to speech or voice data. Rather, it is quite common for users to surf the Internet, receive email messages, send instant messages, and exchange data files using their cellular phones. Effectively, the distinctions between cellular phones and mobile computer devices, such as a personal digital assistants, are greatly diminished or nonexistent in some cases. Since cellular phones are able to offer users such flexibility and exceptional features, there has been a great influx in the number of new subscribers in the past few years. As a result, the resources of individual communication networks are often utilized to their maximum capacity.

To accommodate such demanding traffic on the communication network, the cellular industry has deployed new mobile switching center (“MSC”) technologies, such as softswitch, that are more flexible than existing MSCs. The challenge, however, is how to optimally deploy new MSCs into an existing system with these legacy MSCs. Operators need more creative ways to deploy these new MSC technologies as they face multiple competing problems, such as the MSC capacity being exhausted, the multi-vendor feature incompatibility of the core network and the radio controller, and the need for rolling migration per subscriber. Another problem is that any implementation is locked into the legacy vendors' roadmaps (e.g., Special Mobile Radio (NT-SMR)), but at the same time, a migration path from the obsolete MSCs (e.g., Electronic Mobile Exchange (“EMX”), Digital Multiplex System (“DMS”), and Mobile Telephone Exchange (“MTX”)) to these new type of MSCs implemented with softswitch technology must be provided.

One prior proposed solution to these problems is to replace all existing legacy MSCs simultaneously. Another prior solution suggests implementing the new technologies at the dedicated radio controllers. One significant problem is, however, to minimize the intrusion of these new technologies into an existing system. The preferred choice of the MSC is done on a per-subscriber basis, because any outage experienced by the total system is lessened during the replacement scenario, which is not addressed by these prior proposed solutions.

### BRIEF DESCRIPTION OF THE DRAWINGS

The above needs are at least partially met through provision of the integration method and apparatus described in the following detailed description, particularly when studied in conjunction with the drawings, wherein:

FIG. 1 comprises a block diagram of a wireless communication system suitable for various embodiments of the invention;

FIG. 2 comprises a flow diagram of an access request process by the radio access network according to an embodiment of the invention;

FIG. 3 comprises a flow diagram of a re-routing request process according to an embodiment of the invention;

FIG. 4 comprises a flow diagram of an access request process by the mobile switch center according to an embodiment of the invention;

FIGS. 5A and 5B comprise a call flow diagram of a registration of a mobile station that is to be served by a new MSC according to an embodiment of the invention;

FIGS. 6A and 6B comprise a call flow diagram of a registration of a mobile station that is to be served by a legacy MSC according to an embodiment of the invention;

FIG. 7 comprises a call flow diagram of a registration by a mobile station with a temporary mobile subscriber identity according to an embodiment of the invention;

FIG. 8 comprises a call flow diagram of a service request from a message originated with a temporary mobile subscriber identity according to an embodiment of the invention;

FIG. 9 comprises a call flow diagram of a service request from a message originated without a temporary mobile subscriber identity according to an embodiment of the invention;

FIG. 10 comprises a call flow diagram of a termination request with a temporary mobile subscriber identity according to an embodiment of the invention;

FIG. 11 comprises a call flow diagram of a termination request without a temporary mobile subscriber identity according to an embodiment of the invention;

FIG. 12 comprises a flow diagram of an access request process by the radio access network using a temporary mobile subscriber identity in accordance with an embodiment of the invention;

FIG. 13 comprises a flow diagram of a re-routing request process using a temporary mobile subscriber identity in accordance with an embodiment of the invention;

FIG. 14 comprises a flow diagram of a registration process by the mobile switch center using a temporary mobile subscriber identity in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common and well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, in a communication system having a first and second type of mobile switching center (MSC), an access request from a mobile station is first assessed to determine whether it should be associated with a second type of MSC. If so, the access request is routed to a MSC of the second type. Otherwise, in one embodiment, the access request is routed to a MSC of the first type responsive to a message to associate the access request to the first type of MSC. According to another embodiment, the association to the second type of MSC is based on the access request being identified with a temporary identifier. In one embodiment, the access request is further checked to determine whether it is a registration. If so, the access request is routed to a mobile station of the second type.

According to one embodiment, it is determined whether the access request should be associated with the second type of MSC. This is determined, in various embodiments, using profile information of the mobile station, load-balance information of the second type of MSC, and/or a predetermined function of a mobile station of the second type. If the access request should be associated with the second type of MSC, an association between the mobile station and the second type of MSC is assigned. Otherwise, the message to associate the access request to the first type of MSC is sent.

Pursuant to such embodiments, an improved integration system of different types of MSCs of a communication network has been provided. For example, a second type of MSC can be gracefully merged with a first type of MSC with minimal detrimental replacement effects that could otherwise deteriorate the efficiency of the network. Moreover, new systems can be integrated more slowly, instead of via one broad brush stroke throughout the system. These various embodiments further allow for the selection of the service MSC to a mobile station be done using information that is specific to a subscriber (e.g., data user, authorization for push-to-talk, legal limits in the area, prepaid billing restrictions, etc.). In other words, the selection of the MSC to handle a particular mobile station can now be done on a per-subscriber basis. These various teachings provide for a more efficient system in that once an association is made between the mobile station and the second type of MSC, no additional messaging overhead is necessarily required to process originations or terminations. As a result, a database is no longer needed in the radio controller to perform decision-making functions or retain the decision that has been made. These and other benefits will become more evident to those skilled in the art upon making a thorough review and study of the following detailed description.

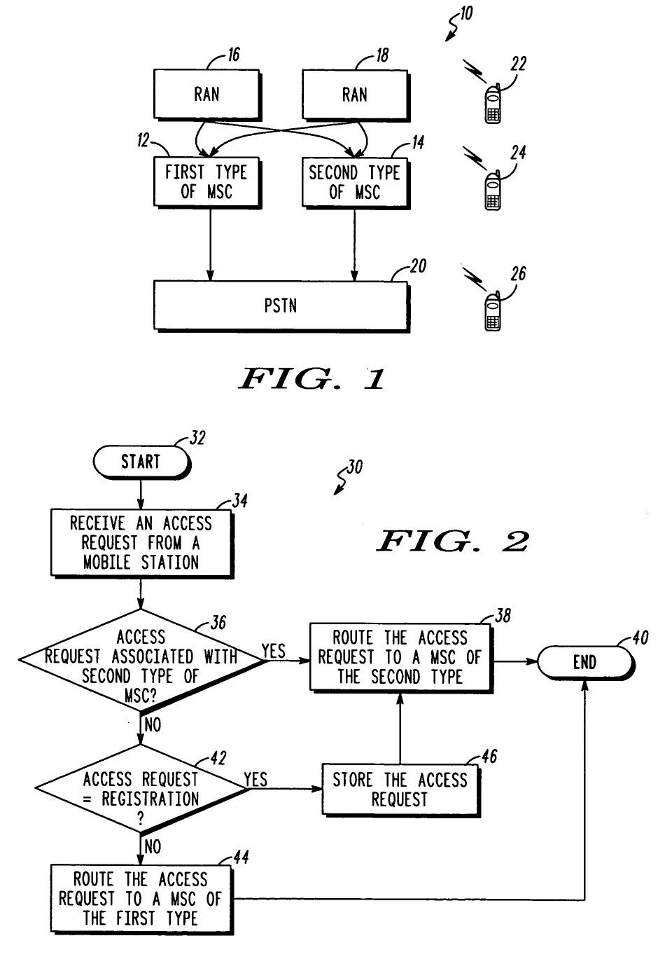

Referring now to the drawings, and in particular to FIG. 1, for purposes of providing an illustrative but nonexhaustive example to facilitate this description, a specific operational paradigm using a Code Division Multiple Access (CDMA) communication network will be presented. Those skilled in the art will recognize and appreciate that the specifics of this illustrative example are not specifics of the invention itself and that the teachings set forth herein are applicable in a variety of alternative settings.

Pursuant to this example, a CDMA communication system 10 is shown with two types of MSC, specifically a first 12 and second type 14. Various embodiments contemplate more than two types of MSC in the system 10, but for clarity and simplicity, only two types of MSC are shown as an illustrative example. Both types of MSC 12, 14 are operably connected to one or more radio access networks (RAN) 16, 18 (two shown) and a Public Switched Telephone Network (PSTN) 20. Typically, multiple mobile stations 22, 24, 26 request services via the RANs 16, 18 at any given time. For example, a first mobile station 22 that is requesting the service sends an access request to the RAN 16, which is connected to both types of MSCs 12, 14. Through the use of the RAN 16 and the MSCs 12, 14, the access request is properly routed and serviced in the system 10. Using the teachings of the various embodiments, modifications to the RANs 16, 18 along with the new functionalities offered by the second type of MSC 14, a base station controller of any particular base station (not shown) is able to support two independent A1/A2 interfaces, specifically one directed to the first type of MSC 12 and another directed to the second type of MSC 14. The communication system shown, however, is an exemplary implementation within the CDMA technology. Numerous other communication systems and networks are contemplated by these teachings, and thus, they are contemplated and within the scope of the invention.

Referring to FIG. 2, a flow diagram of an access request process by the RAN according to an embodiment is shown and indicated generally at 30. According to this embodiment, this process is preferably implemented in the RANs, because the access requests are typically sent to the RAN from the mobile station. However, other network controllers or modules in the system may also be implemented with the present process, and these other implementations are again within the scope of the invention. The process is initiated 32 by an access request being received 34 from the mobile station, but as noted, the access request may not necessarily be sent directly from the mobile station. It is next determined 36 whether the access request is associated with the second type of MSC.

In one embodiment, this is determined by a temporary mobile subscriber identity (TMSI) being included with the access request. By implementing a change with the access request on the mobile station side, the second type of MSC is integrated into the system without changing mobile stations that work with the first type of MSC, such as an existing MSC. As a result, the change in the system can be done on a per-subscriber basis, which allows for smoother replacement or integration of new systems into an existing system. Other techniques of association are, however, contemplated. If the access request is associated with the second type of MSC, it will accordingly be routed 38 to a MSC of the second type. The process ends 40 with routing of the access request to a MSC.

If, however, it is not clear to the RAN whether the access request is associated with the second type of MSC, it is checked 42 whether the access request is a registration. If the access request is not a registration, which means it is most likely an access request that is associated with the first type of MSC, the access request is accordingly routed 44 to a MSC of the first type for servicing. The process again ends 40, since the access request has been properly routed. If the access request is a registration, the access request is stored 46 and routed 44 to a MSC of the second type for registration processing, which ends 40 the process. Note that the registration process is done at a MSC, instead of the RANs. Because the MSC will ultimately be serving the access request, it is more efficient that the MSC actually makes the decision relating to its own registration. Furthermore, a database is not needed in the radio controller to perform the decision making functions or retain the decision that has been made.

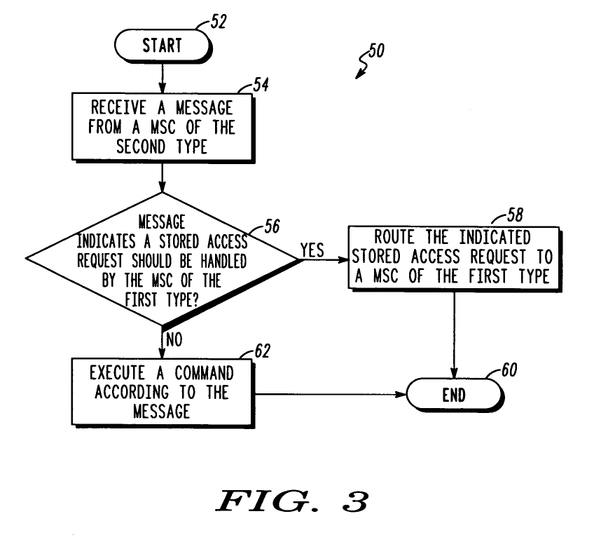

Turning now to FIG. 3, a flow diagram of a re-routing request process according to an embodiment of the invention is shown and indicated generally at 50. Corresponding to the process shown in FIG. 2, this process is implemented in the RAN. As noted, however, other implementations are contemplated, and other modules can also be implemented with the present process. In this embodiment, the process is initiated 52 by a message being received 54 from a MSC of the second type. It is determined 56 whether this message indicates that a stored access request should be handled by the MSC of the first type. If so, as indicated, the process routes 58 the access request that was stored at one time from FIG. 2 to a MSC of the first type, and the process is then completed 60. If the message does not relate to routing the access request to the first type of MSC, a command is executed 62 as indicated by the message.

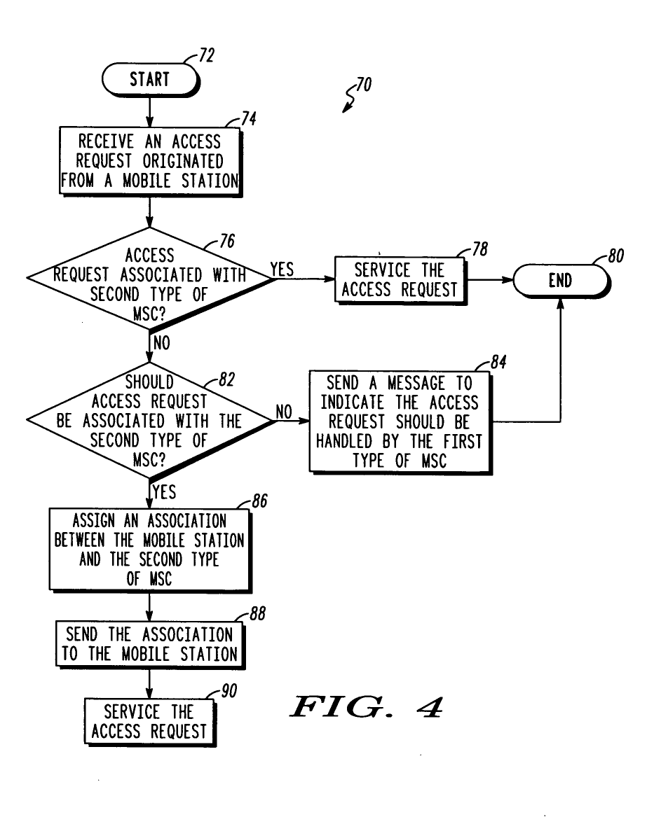

Referring to FIG. 4, a flow diagram of a registration process by the MSC that accords with these teachings is shown and indicated generally at 70. This process, according to one embodiment, is implemented within MSCs of the second type, such as softswitch MSCs, but as noted, other implementations are contemplated as will be appreciated by a skilled artisan. The process starts 72 with the process receiving 74 an access request originated from a mobile station. The access request is actually sent from the RAN to the process corresponding to the embodiments shown in FIGS. 2 and 3. The access request is first checked 76 to determine whether it is associated with the second type of MSC, which is indicated by a temporary mobile subscriber identity according to one embodiment. If so, the access request is accordingly serviced 78, which ends 80 the process.

If the access request did not include any indication of an association to the second type of MSC, the process has to determine 82 whether the access request, specifically the mobile station that sent the access request, should be in fact associated with the second type of MSC. This particular decision can be made based on a number of parameters depending on the configuration of the communication system. For example, the profile information (e.g., mobile protocol revision level, capabilities, compatibilities, or subscription from the Home Location Register) of the mobile station can be considered, or the load-balance information of the MSC can also be considered. In fact, any predetermined function of the MSC of the second type can be used, such as load shedding based on a mathematical formula. These criteria are readily appreciated by one skilled in the art. Furthermore, because it is impractical to reiterate every possible criteria, other implementations using various criteria are within the scope of these various teachings.

Turning back to FIG. 4, if it has been determined that the access request should not be associated with the second type of the MSC, a message to indicate that the access request should instead be handled by the first type of MSC is sent 84, and the process ends 80. The message, according to these embodiments shown, is sent to the RAN for rerouting to a MSC of the first type. If, oppositely, it has been determined that the access request should be associated with the second type of MSC, the mobile station is assigned 86 and sent 88 an association to the second type of MSC, wherein some of the subsequent communication from the mobile station is identified with this association to the second type of MSC. In one embodiment, subsequent access requests from the mobile station are identified with a temporary mobile subscriber identity for association with the second type of MSC. After the mobile station has been registered, the access request is accordingly serviced 90 by the MSC of the second type.

From these various teachings, the selection of a service MSC can be done using information that is specific to a subscriber mobile station or a MSC servicing the request. As a result, the MSC handles its own service priority of the mobile stations. Moreover, the decision relating to service is now done on a per-subscriber basis, and once an association is made between the mobile station and the second type of MSC, no additional messaging overhead is required to process originations or terminations. The MSC of the second type can be merged gracefully with the MSCs of the first type of MSC with minimal intrusion to the system. These and other benefits will be apparent to one skilled in the art, and as an example, the remaining description will relate to a specific embodiment of integrating new MSCs (e.g., softswitch MSCs) to existing MSCs of a communication system.

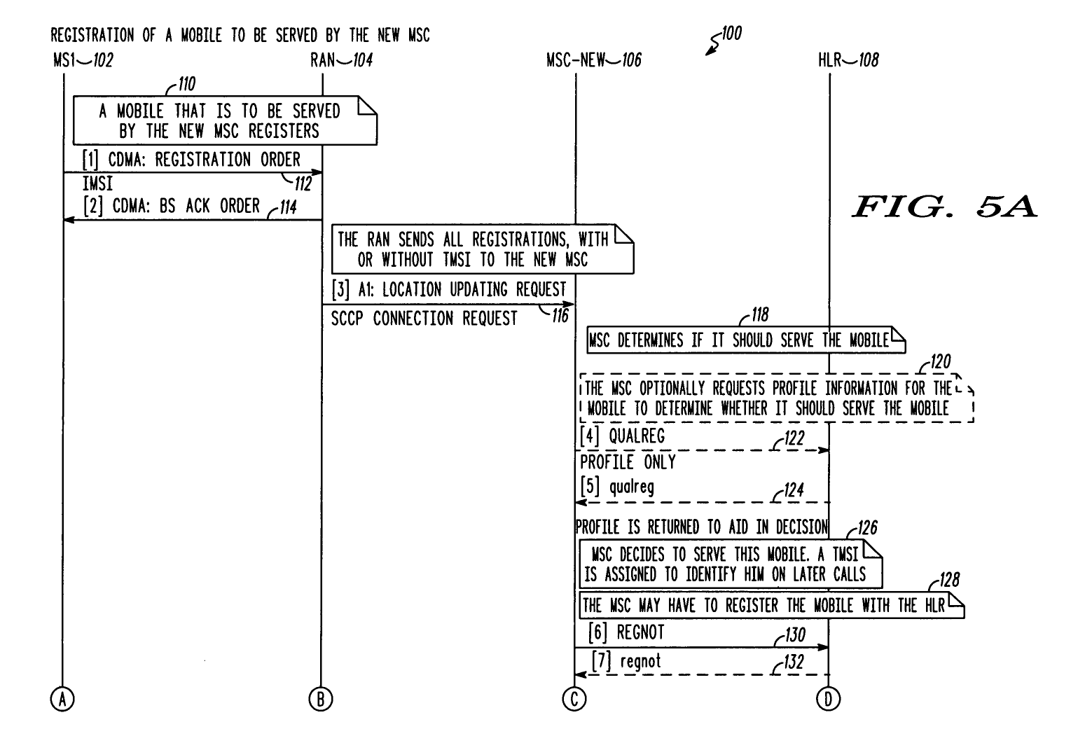

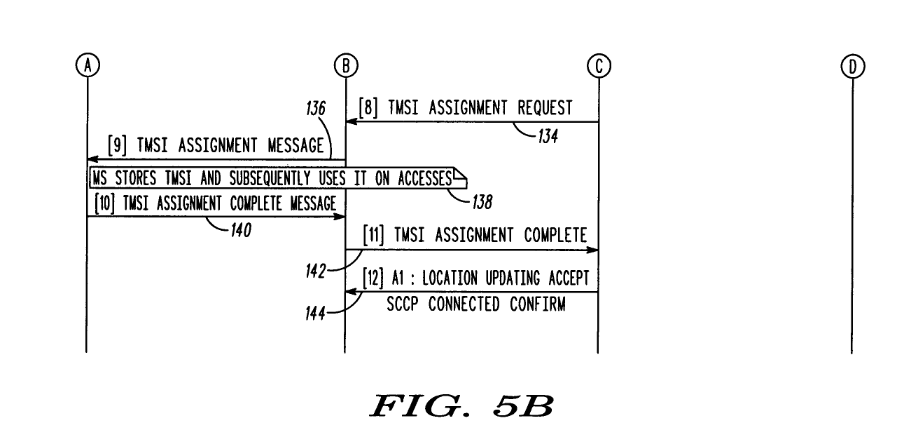

FIGS. 5A and 5B show a call flow diagram of a registration of a mobile station on a new MSC, which is indicated generally at 100. The overall process is initiated by a message from a mobile station 102 to a RAN 104, which is linked to a new MSC 106 that in turn is linked to a Home Location Register (HLR) 108. The mobile station 102 (MS1) refers to the mobile that will ultimately be served by the new MSC registers. A registration order is sent 112 from the MS1 to the RAN, and in response, the RAN sends 114 back a base station acknowledgement order to the MS1. In this embodiment, since the RAN sends all registrations, with or without a temporary mobile subscriber identity (TMSI) to the new MSC, the RAN sends 116 a location updating request (e.g., a Signaling Connection Control Part (SCCP) Connection Request) to the new MSC. Responding to the request, the new MSC determines 118 whether it should serve this particular mobile, and may optionally request 120 profile information from the mobile to make such a determination. A qualification request (QUALREQ) is sent 122 to the HLR, which returns 124 the qualification request to the new MSC once the MS1 102 has been validated. Between the validation information from the HLR and the optional profile information, the new MSC decides to serve the MS1 102 and assigns 126 a TMSI to identify the MS1 for later calls. The new MSC, at this time, may also register 128 the MS1 with the HLR by sending 130 a registration notification (REGNOT), which will be returned 132 from the HLR upon registration. The new MSC sends 134 a response with the assigned TMSI to RAN responsive to the TMSI assignment request. The RAN forwards 136 the information to the MS1. Accordingly, the MS1 saves the TMSI and subsequently uses 138 the TMSI for future access request. To complete the process, the MS1 returns 140 an assignment complete message to the RAN. The RAN, in response, sends 142 a TMSI assignment complete message to the new MSC. The new MSC then sends 144 the location update accept message back to the RAN to indicate that the SCCP connection has been confirmed.

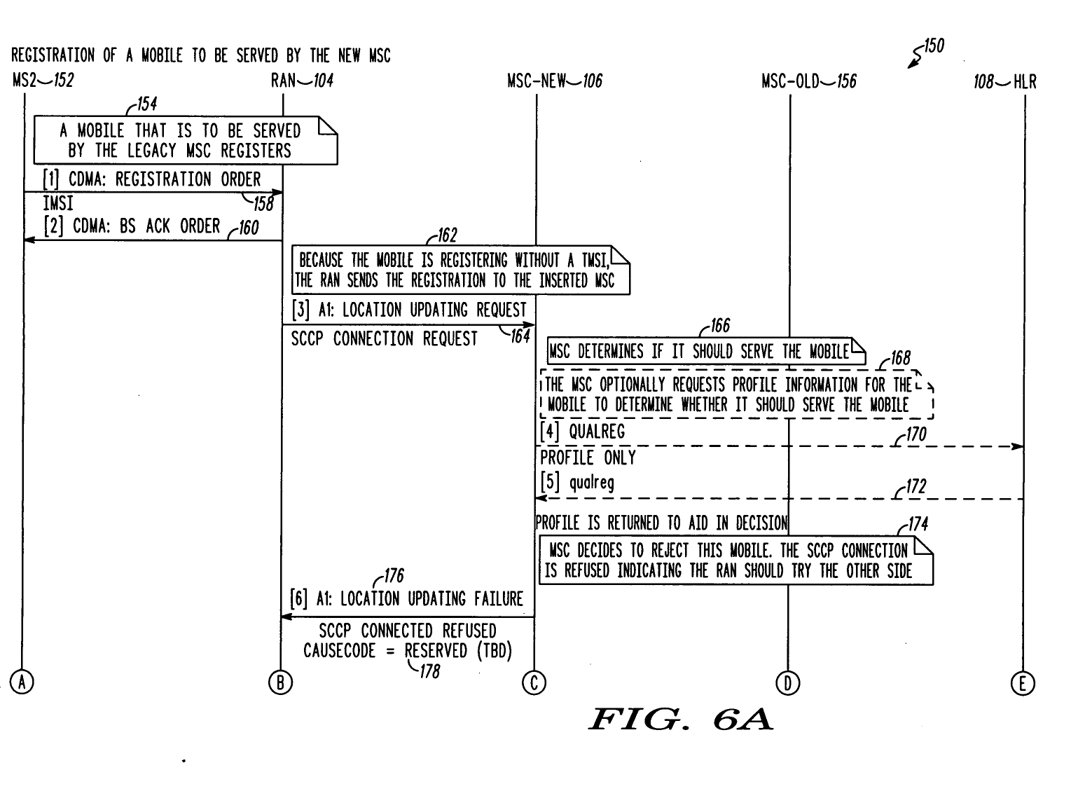

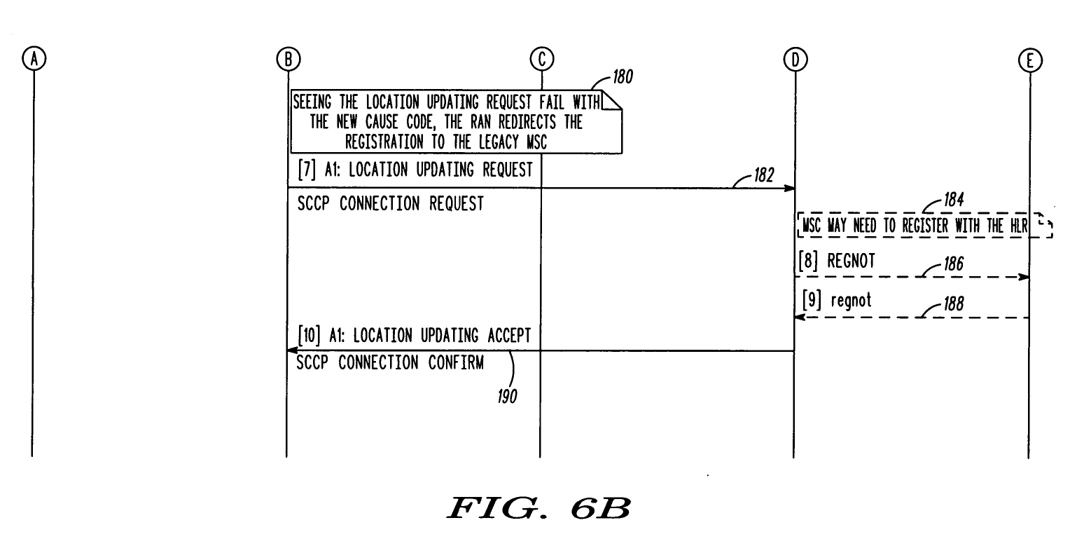

FIGS. 6A and 6B show a call flow diagram 150 of a registration of a mobile station (MS2) 152 to be served 154 by a legacy MSC (e.g., old MSC) 156. The MS2 sends 158 a registration order to the RAN 104, which responds 160 with a base station acknowledgement order. In this case, because the MS2 is registering without a TMSI, the RAN sends 162 the registration to the newly inserted MSC (e.g., the new MSC 106), specifically a location updating request is sent 164 to the new MSC 106 as a SCCP connection request. Same as before, the new MSC determines 166 whether it will serve the MS2. This criteria is again based on optionally requested profile information from the MS2 168 and/or quantifier request 170 to the HLR 108 and validation 172 from the HLR 108 to the new MSC. Unlike before in FIG. 5, this time the new MSC rejects the MS2 and refuses the SCCP connection, and indicates 174 to the RAN that it should try the other side (e.g., the old MSC) by sending a location updating failure 176. Specifically, in this case, the location updating failure includes an entry of “SCCP Connected Refused CauseCode=Reserved (TBD) 178,” and the RAN redirects 180 the registration to the legacy MSC (e.g., old MSC) for a SCCP connection request by sending 182 a location updating request to the old MSC 156. The old MSC may need to register 184 with the HLR and a registration notice (REGNOT) is exchanged 186, 188 between the old MSC and the HLR. The SCCP connection is confirmed when the old MSC sends 190 a location updating accept message to the RAN.

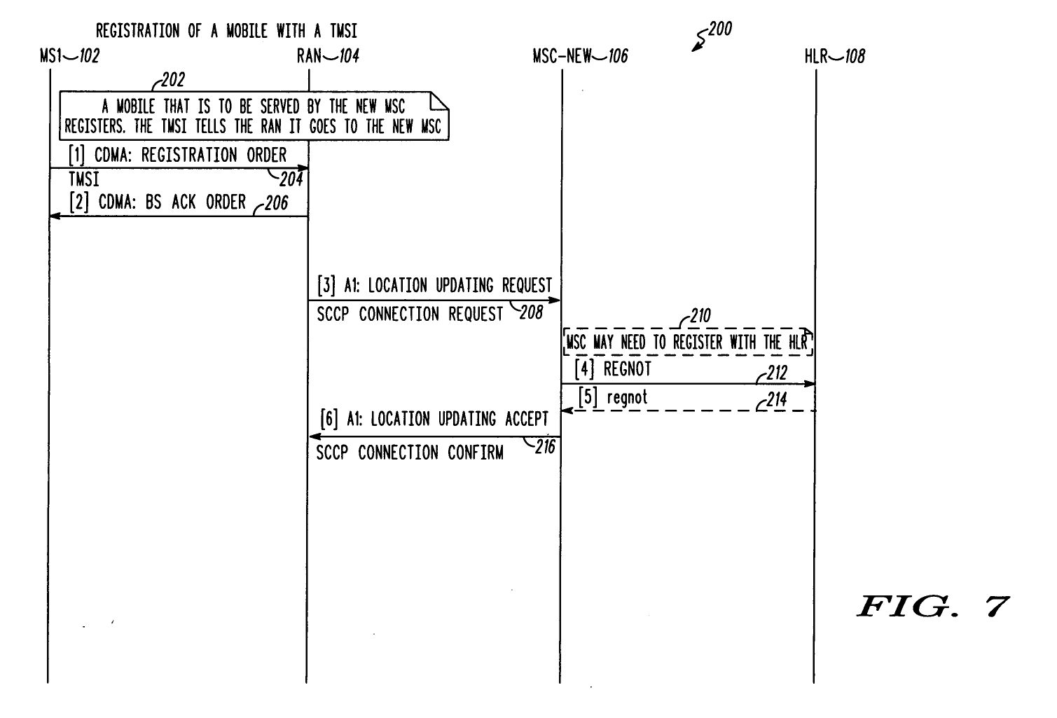

Referring now to FIG. 7, a call flow diagram of a registration by a mobile with a temporary mobile subscriber identity is shown and indicated generally at 200. Since the MS1 102 that is to be served by the new MSC registers is already identified 202 with a TMSI, which indicates to the RAN that its access request should be routed to a new MSC, a determination of what type of MSC should service this request is not needed. And as before, a registration order is sent 204 by the MS1, and a base station acknowledgement order is returned 206 from the RAN to the MS1, in response. The RAN accordingly sends 208 a location updating request for the SCCP connection to the new MSC. The new MSC may again need to register 210 with the HLR by sending 212 a registration notice (REGNOT) to the HLR, which is returned 214 from the HLR once registered. Once the registration of the SCCP connection has been confirmed, the new MSC 106 sends 216 the location updating accept message to the RAN.

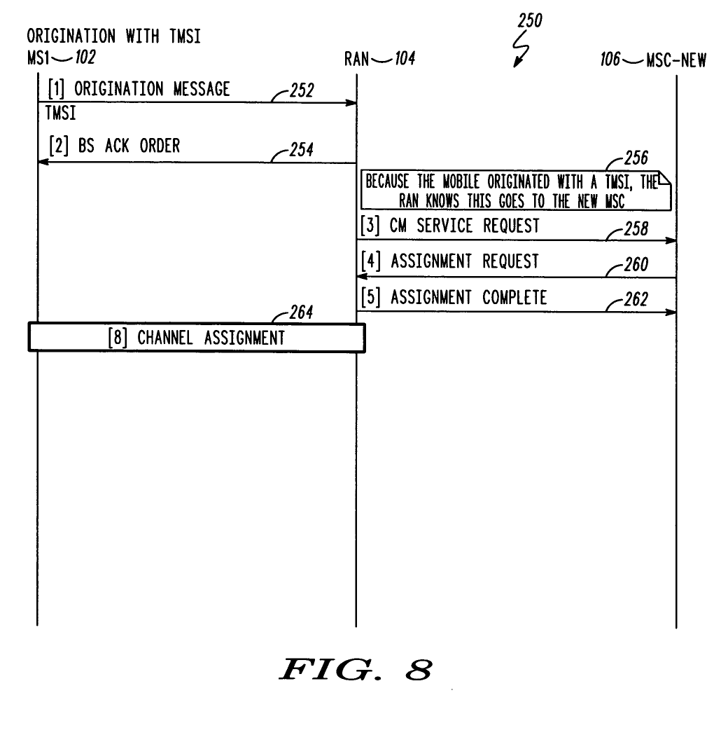

FIG. 8 shows a call flow diagram of a service request from a message that originated with a temporary mobile subscriber identity, which is generally indicated at 250. The origination message is sent 252 from the MS1 102 to the RAN 104 for service request, specifically an access request of a channel assignment. The RAN 104 accordingly acknowledges the MS1's request by sending 254 a base station acknowledgement order back to the MS1. Because the mobile station's message is originated with a TMSI, the RAN knows 256 that the service request goes to the new MSC 106. As such, the RAN 104 sends 258 a Connection Management (CM) service request to the new MSC 106, and in response, an assignment request is returned 260 from the new MSC to the RAN. The RAN informs the new MSC once the assignment has been completed by sending 262 an assignment complete message. As a result, a channel assignment 264 has been effectuated between the MS1 and the new MSC via the RAN.

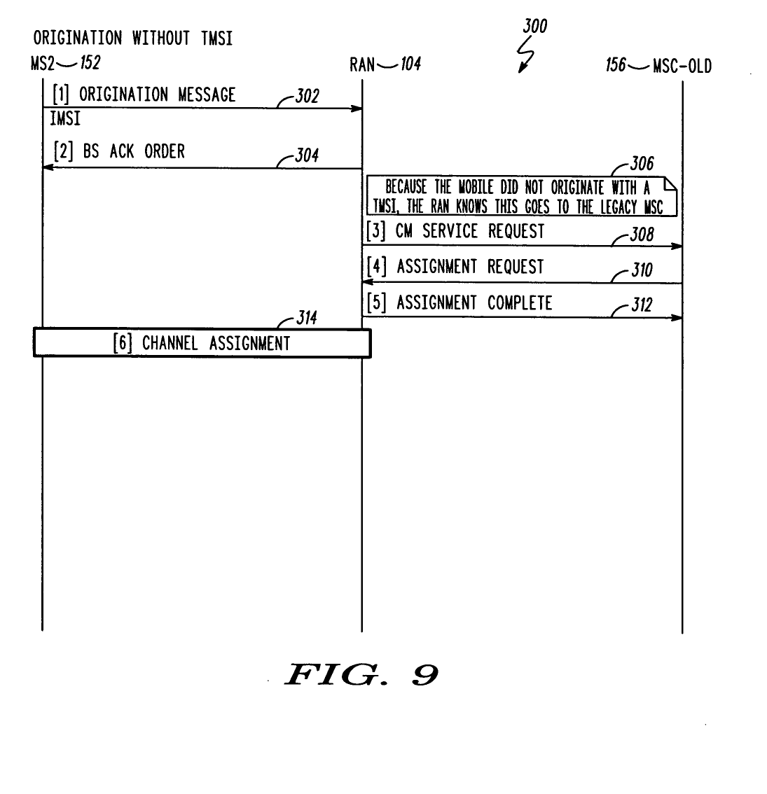

FIG. 9 shows a call flow diagram of an access request by a message without a temporary mobile subscriber identity, which is indicated generally at 300. In this case, the message is originated 302 from the MS2 152 to the RAN 104 for processing, and in response, the RAN accordingly sends 304 a base station acknowledgement order back to MS2. Because the mobile station's message did not include a TMSI and the message is not registration, the RAN knows 306 that the message should be serviced by a legacy MSC. The RAN, as a result, will accordingly send 308 a CM service request to the old MSC. An assignment request is returned 310 from the old MSC to indicate the channel assignment, and the RAN sends 312 an assignment complete message once a channel assignment has been assigned 314 to the MS2.

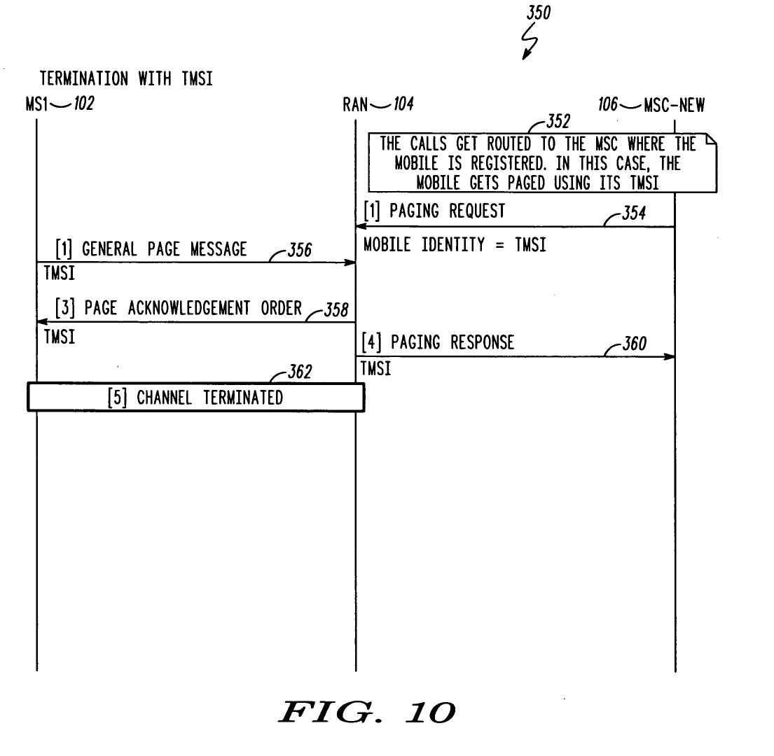

FIG. 10 shows a call flow diagram of a termination request with a TMSI according to an embodiment of the invention, which is indicated generally at 350. Once the MS1 102 is registered and assigned a channel assignment, the calls of the MS1 are routed to the new MSC with which it is registered with. In this case, if the new MSC, for some reason, needs to page the MS1, the TMSI is used 352. To initiate a paging request, the new MSC 106 sends 354 the request with a mobile identity using the TMSI that was assigned to the MS1 to the RAN. The RAN, in response, sends 356 a general page message to the MS1, and expects a page acknowledgement order to be returned 358 from the MS1. The acknowledgement order includes instructions of the MS1's response to the page from the new MSC, which is sent 360 with the TMSI, as a response, back to the new MSC via the RAN. In the example, the page from the new MSC is a termination request, and the channel between the MS1 and the new MSC will be terminated 362.

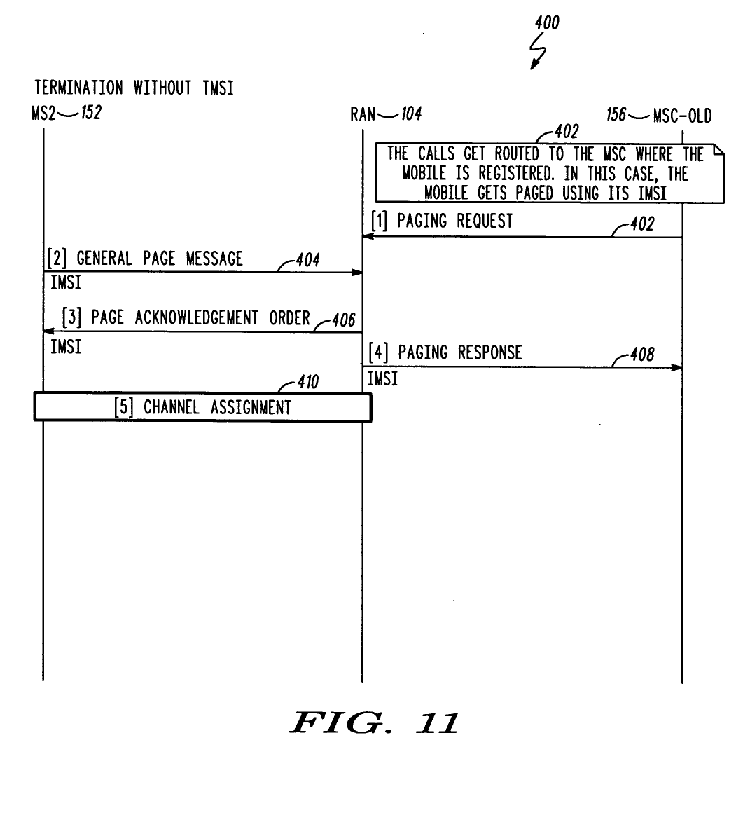

Turning now to FIG. 11, a call flow diagram of a termination request without the TMSI according to an embodiment of the invention is shown and indicated generally at 400. As typically done, the calls are routed to the MSC where the mobile station is registered. In this case, the MS2 152 is paged 402 using the international mobile subscriber identifier (IMSI), instead of the TMSI, because the MS2 is served by the old MSC 156. Specifically, the old MSC 156 sends 402 a paging request message, which includes a mobile identity using the IMSI, to the RAN, and in response, the RAN sends 404 a general page message to the MS2. The MS2 accordingly sends 406 a page acknowledgement order back to the RAN, in which it is forwarded 408 to the old MSC with a paging response. From this example, the channel assignment is thus terminated 410, as expected. FIGS. 5-11 show exemplary call flow diagrams in a specific implementation within a CDMA network using a TMSI as an association to the new MSC. Please note that these examples were given to provide a practical description of the teachings of various embodiments. Multiple other implementations are contemplated and are readily appreciated by one skilled in the art, and thus they are within the scope of the invention.

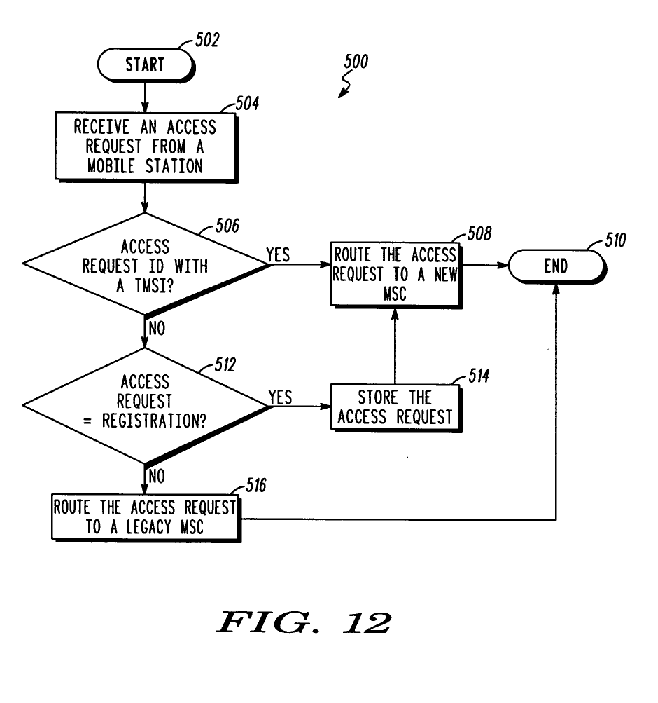

Referring now to FIG. 12, a flow diagram of an access request process by the RAN using the TMSI in accordance with an embodiment of the invention is shown and indicated generally at 500. The process is initiated 502 by an access request from a mobile station being received 504. In response to the request, it is determined 506 whether the access request is identified with a TMSI. If so, the request is automatically routed to the new MSC, which ends 510 the process. If, on the other hand, the request is not identified with the TMSI, it is determined 512 whether the access request is in fact a registration. If so, the access request is stored or queued 514 so that it can be referenced by the process at a later time. The request is then routed 508 to the new MSC for the registration process, and this completes 510 the process. Otherwise, if the access request is not a registration, it will be routed 516 to the legacy MSC, since it was not identified with a TMSI.

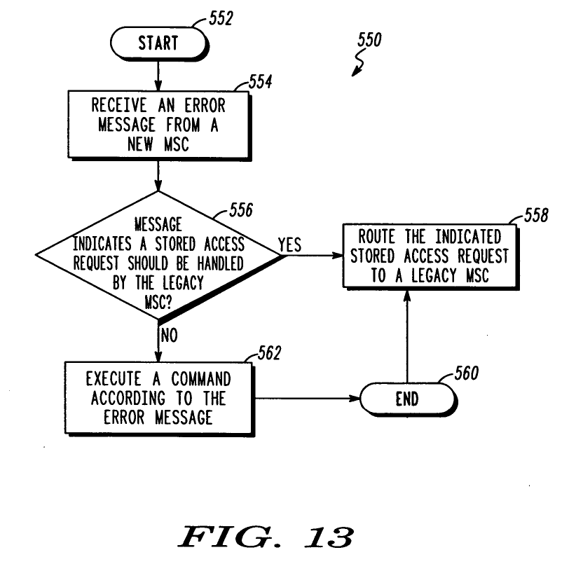

Turning to FIG. 13, a flow diagram of a re-routing request process using the TMSI in accordance with an embodiment of the invention is shown and indicated generally at 550. The process starts 552 with an error message being received 554 from a new MSC. In response to the message, it is determined 556 whether this message indicates that a stored or queued access request should be handled by the legacy MSC. If so, the message is accordingly routed 558, as indicated, to the legacy MSC, which ends 560 the process. If the message does not relate to routing a stored access request to the legacy MSC, a command relating to the error message is executed 562, as typically done in a general system. The process is completed 560 once the message has received a response.

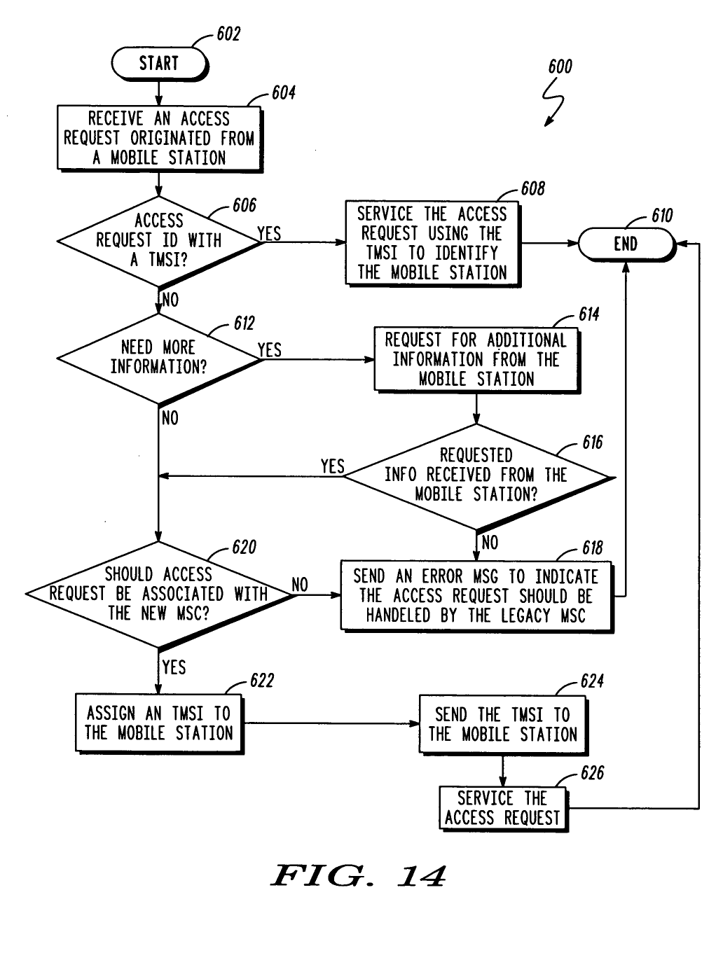

Referring now to FIG. 14, a flow diagram of a registration process by the MSC using the TMSI in accordance with an embodiment of the invention is shown and indicated generally at 600. The process is initiated 602 by receiving 604 an access request that originated from a mobile station. It is first checked 606 whether the access request is identified with the TMSI, and if so, the process, mostly implemented in the new MSC, would simply service 608 the access request using the TMSI as an identification of the mobile station. The process ends 610, since the access request has been serviced. If, however, the access request is not identified with a TMSI, the process determines 612 whether additional information is needed. If so, a request is made 614 to the mobile station for additional information, which is checked 616 to determine whether the mobile station did in fact respond to the request. When the mobile station fails to send the requested information, an error message is sent 618 to indicate that the access request should be handled by the legacy MSC, which ends 610 the process.

If, on the other hand, the mobile station did comply with the request, and sent the requested information, it is next determined 620 whether the new MSC should service this mobile station, specifically whether the access request should be associated with the new MSC. If not, the error message to indicate that the access request should be handled by the legacy MSC is sent 618, which concludes 610 the process. If, however, it has been determined that the access request should be associated with the new MSC, a TMSI is assigned 622 and sent 624 to the mobile station. The process would similarly end 610 once the process services 626 the access request.

With that understanding, an improved integration technique of different types of mobile switching centers has been provided through the use of the various teachings shown. Unlike the currently available options, a second type of MSC is gracefully merged with a first type of MSC with minimal detrimental replacement effects. As a result, new systems can be integrated more slowly on a per-subscriber basis. Moreover, the various embodiments allow for the selection of a service MSC to a mobile unit be done using information that is specific to a subscriber (e.g., data user, authorization for push-to-talk, legal limits in the area, etc.). Once an association is made between the mobile unit and the second type of MSC, no additional messaging overhead is required to process originations or terminations. Thus, a database is not needed in the radio controller to perform decision making functions or retain the decision that has been made. These benefits translate into an improved integration system using multiple types of MSC in a communication network.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method of integrating a second type of mobile switching center into a communication system comprising at least in part a first type of mobile switching center comprising:
receiving an access request originated by a mobile station;
determining whether the access request is associated with the second type of mobile switching center;
routing the access request to a mobile switching center of the second type when the mobile station is associated with the second type of mobile switching center.

2. The method according to claim 1, wherein the second type of mobile switching center is based on legacy technology and the first type of mobile switching center is based on newer technology that is both newer and different, in at least some respects, than the legacy technology.

3. The method according to claim 1, wherein the first type of mobile switching center is based on non-softswitching technology and the second type of mobile switching center is based on softswitching technology.

4. The method according to claim 1, wherein determining whether the mobile station is associated with the second type of mobile switching center further comprises:
determining whether the access request is identified with a temporary identifier, wherein the mobile station is associated with the second type mobile station when the access request is identified with the temporary identifier.

5. The method according to claim 1 further comprising:
determining whether the access request is a registration when the mobile station is not associated with the second type of mobile switching center;
routing the access request to a mobile switching center of the second type when the access request is a registration;
routing the access request to a mobile switching center of the first type when the access request is not a registration.

6. The method according to claim 1 further comprising:
receiving a message that indicates the access request from the mobile station should be associated with the first type of mobile switching center;
routing the access request to the first type of mobile switching center responsive to the message.

7. The method according to claim 1, wherein the communication system is a Code Division Multiple Access system.

8. A method of integrating a second type of mobile switching center to a communication system comprising at least in part a first type of mobile switching center comprising:
receiving an access request originated from a mobile station;
determining whether the access request is associated with the second type of mobile switching center;
determining whether the mobile station should be associated with the second type of mobile switching center when the access request is not associated with the second type of mobile switching center;
assigning an association between the mobile station and the second type of mobile switching center when the mobile station should be associated with the second type of mobile switching center;
sending a message to indicate that the access request should be associated with the first type of mobile switching center when the mobile station should not be associated with the second type of mobile switching center.

9. The method according to claim 8, wherein the first type of mobile switching center is based on new technology and the second type of mobile switching center is based on existing technology.

10. The method according to claim 8, wherein the first type of mobile switching center is based on non-softswitching technology and the second type of mobile switching center is based on softswitching technology.

11. The method according to claim 8 further comprising servicing the access request when the access request is asssociated with the second type of mobile switching center.

12. The method according to claim 8, wherein determining whether the access request is associated with the second type of mobile switching center further comprises:
determining whether the access request is identified with a temporary identifier associated to the second type of mobile switching center;
identifying the access request as being associated with the second type of mobile switching center when the access request is identified with the temporary identifier;
identifying the access request as not being associated with the second type of mobile switching center when the access request is not identified with the temporary identifier.

13. The method according to claim 8, wherein determining whether the mobile station should be associated with the second type of mobile switching center is based on any one or more from a group of profile information of the mobile station, load-balance information of a mobile switching center of the second type, and predetermined function of a mobile switching center of the second type.

14. The method according to claim 8, wherein assigning an association between the mobile station and the second type of mobile switching center further comprises:
assigning a temporary identifier to the mobile station;
sending the temporary identifier to the mobile station, wherein at least some subsequent communication from the mobile station is identified with the temporary identifier.

15. A system of integrating a second type of mobile switching center into a communication system comprising at least in part a first type of mobile switching center comprising:
a first type of mobile switching center adapted to service access requests from mobile stations;
a second type of mobile switching center operably coupled to the first type of mobile switching center, wherein the second type of mobile switching center is adapted to assign a temporary identifier to associate a mobile station with the second type of mobile switching center, service access requests with the temporary identifier, and send a message to associate an access request with the first type of mobile switching center;
a radio access network node operably coupled to the first and second type of mobile switching centers, wherein the radio access network node is adapted to route an access request with the temporary identifier to the second type of mobile switching center, route a registration request to the second type of mobile switching center, and route an access request to the first type of mobile switching center responsive to the message to associate the access request with the first type of mobile switching center.

16. The system as defined in claim 15, wherein the first type of mobile switching center is based on non-softswitching technology and the second type of mobile switching center is based on softswitching technology.

17. The system as defined in claim 15 further comprising:
a mobile station adapted to save the temporary identifier from the second type of mobile switching center, wherein at least some subsequent communication from mobile station is identified by the temporary identifier.

18. The system as defined in claim 15, wherein the second type of mobile switching center is further adapted to determine whether a mobile station should be associated with the second type of mobile switching center based on any one or more from a group of profile information of the mobile station, load-balance information of a mobile station of the second type, and predetermined function of a mobile station of the second type.

19. The system as defined in claim 15, the second type of mobile switching center comprises:
means for assigning a temporary identifier to associate a mobile station with the second type of mobile switching center;
means for servicing an access request with the temporary identifier;
means for sending a message to associate an access request with the first type of mobile switching center.

20. The system as defined in claim 15, wherein the radio access network node comprises:
means for routing an access request with the temporary identifier to the second type of mobile switching center;
means for routing a registration request to the second type of mobile switching center;
means for routing an access request to the first type of mobile switching center responsive to the message to associate the access request with the first type of mobile switching center.
